(19) United States
(12) Patent Application Publication
(10) Pub. No.: US 2018/0341877 A1
(43) Pub. Date: Nov. 29, 2018

(54) ESCALATION OF MACHINE-LEARNING INPUTS FOR CONTENT MODERATION

(71) Applicant: Microsoft Technology Licensing, LLC, Redmond, WA (US)

(72) Inventors: Jennifer A. PANATTONI, Seattle, WA (US); Roberta MCALPINE, Lynnwood, WA (US); Kailas B. BOBADE, Redmond, WA (US); Matt J. WILSON, Duvall, WA (US); Colin WILLY, Bellevue, WA (US)

(21) Appl. No.: 15/605,331

(22) Filed: May 25, 2017

(51) Int. Cl. G06N 99/00; G06F 17/30

(52) U.S. Cl. CPC G06N 99/005; G06F 17/30864

(57) ABSTRACT

A method disclosed herein provides for escalation of machine learning content selection for content moderation use. The method includes requesting reaction feedback from users of an online social community platform in association with each of a number of user-provided content items appearing in the online social community platform. The reaction feedback is analyzed to identify a subset of the user-provided content items satisfying reaction consensus criteria, and content moderation logic is then trained based on the subset of content items identified from the analysis of the reaction feedback to facilitate selective implementation of content moderation actions based on the trained content moderation logic.

### BACKGROUND

Some online service providers utilize content moderation processes to flag and/or remove objectionable content posted to online content-sharing communities (e.g., websites, applications, or platforms for sharing images, video, audio clips, commentary, etc.). One significant challenge in content moderation is determining parameters to define “appropriate” or “inappropriate” content. An automated or semi-automated content moderation process may identify content for potential removal and/or flagging based on application of rigid rules, such as inclusion or non-inclusion of one or more pre-defined terms. Often these processes entail at least some human oversight and/or feedback because language is dynamic, and determining what is objectionable may depend on both context and audience.

### SUMMARY

Implementations described and claimed herein provide a method for escalating machine-learning inputs for content moderation. The method comprises requesting reaction feedback from users of an online social community platform in association with each of several user-provided content items and analyzing the reaction feedback to identify a subset of the user-provided content items satisfying reaction consensus criteria. The method further includes content moderation training logic based on the subset of content items identified from the analysis of the reaction feedback, and selectively performing a content moderation action based on the trained content moderation logic responsive to future identification of one or more content items of the identified subset within the online social community platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system for escalating content to train an automated content moderation process that operates within an online social community platform.

FIG. 2 illustrates an example crowd-source reaction collector that presents various user interfaces for collecting reaction feedback usable to train content moderation logic.

FIG. 3 illustrates example interfaces of another crowd-source reaction collector for collecting reaction feedback from users pertaining user-provided content appearing within an online social community platform.

FIG. 4 illustrates example interfaces of crowd-source reaction collector for collecting reaction feedback from users pertaining to user-provided content appearing within an online social community platform.

FIG. 5 illustrates an interface screen of a feedback aggregator and analyzer usable to generate training inputs for a content moderator.

FIG. 6 illustrates example user interface showing a plot of frequency usage for a particular content item within an online social community platform.

FIG. 7 illustrates an example moderator logic of a content moderation system usable to moderate content in an online social community.

FIG. 8 illustrates example operations for escalating machine-learning selection of a vocabulary of moderated terms for content moderation.

### DETAILED DESCRIPTION

In the digital world, content sharing has become commonplace. People of all ages can upload, download, read, view, watch, listen to, interact with, and otherwise consume online content, including content shared by individuals of diverse interests, ages, and geographic locations. Many service providers that host and manage content-sharing platforms seek to implement processes to moderate objectionable content. However, the sheer magnitude and breadth of user-generated content items can make it difficult if not impossible for these service providers to rely on exclusively manual techniques. As a result, it is common to use semi-automated content moderation processes (also referred to herein as “flagging processes”) that employ automated algorithms to identify potentially objectionable content and rely on humans to review flagged items and/or to continuously update these automated content moderation processes. For example, a content moderation process may flag items for potential removal based on a data store of content pre-identified as “objectionable.” This data store of pre-identified content may be periodically updated to account for newly-identified objectionable content and different forms and variations that may be used. For example, such a data store may include various translations of terms identified as “offensive” into different languages and/or various misspellings of these same terms since it is common for users to intentionally misspell objectionable words for slang purposes.

In addition to these challenges relating to language, culture, and spelling, there exist additional challenges stemming from the subjective determination of whether content is objectionable enough to be removed from on online forum or public space. For example, some content (e.g., terms, phrases, or images) is objectionable to some people but not to other people, and some content is objectionable when appearing in a specific context but not when appearing in another context. Stated differently, content moderation is a highly subjective problem and existing automated solutions are inadequate due to application of hardline rules and/or inadequate considerations of context and/or audience.

The herein disclosed content moderation systems and processes improve upon these solutions by collecting, sorting, and analyzing vast quantities of subjective user inputs to formulate inherently-subjective community-specific and/or context-specific rules applied by an automated content moderation engine. For example, an online community served by a community-specific content moderation process supplies subjective, context-specific feedback that is used to train an automated content-moderation process monitoring that same online community. This, in effect, enables fully-automated content moderation that initiates content moderation actions within an online space that is primarily or exclusively frequented by the same persons who deem that content to be objectionable.

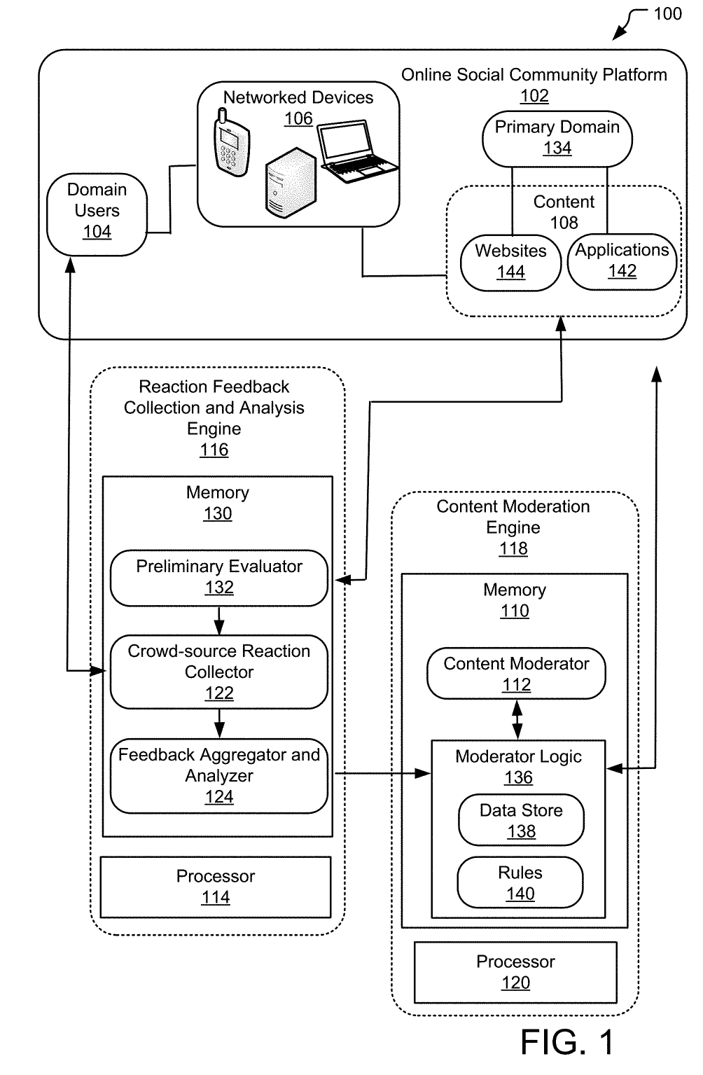

FIG. 1 illustrates an example system 100 for escalating vocabulary to train an automated content moderation process that operates within an online social community platform 102. The online social community platform 102 includes a primary domain 134 and domain users 104 that access content 108 through various networked devices 106. The primary domain 134 makes the content 108 available to the domain users 104 through one or more servers and other networked devices 106. The content 108 is accessible on one or more websites 144 of the primary domain 134 and/or within applications 142 developed by or on behalf of the primary domain 134. In some implementations, the online social community platform 102 may include more than one primary domain, such as when multiple unaffiliated domains utilize a same content moderation service.

The content 108 includes content uploaded by the domain users 104 (e.g., “user-uploaded content), such as content that a user submits for publication within the online social community platform 102 through one or more content-sharing tools or services of the primary domain 134.

In different implementations, the content 108 may include various types of content including without limitation text, images, audio, video (e.g., both prerecorded video and live video streaming, such as streaming of webcam feeds and live game play), mixed reality, etc. As used herein, a “content item” refers to a discrete content element such as an individual term, phrase, sentence, paragraph, full article, image, video file, audio file, etc. In one implementation, the domain users 104 view and/or upload the content 108 to the online social media platform 102 by logging into a personal user account managed by the primary domain 134. For example, a user may login to a web portal of the primary domain 134 with a personal access credential to view and/or share some or all of the content 108. In another implementation, the user downloads a mobile application that is developed by or on behalf of the primary domain 134 to view and/or share some or all of the content 108. To access and/or utilize the downloaded mobile application, the user may be asked to provide login credentials for a personal user account registered with the primary domain 134. For example, the user may access the application by providing the application with login credentials identical to the login credentials that the user provides to view and/or share other web-based content (e.g., the websites 144 of the primary domain 134).

Example primary domains that provide content-sharing websites and/or downloadable applications include without limitation video and photo-sharing domains such as youtube.com and flickr.com; social media websites such as facebook.com and twitter.com; and gaming communities such as xbox.com, Twitch®, Steam®, Beam®, etc.

The content 108 of the online social community platform 102 is moderated by content moderation engine 118, which includes both hardware and software components as described further below. In general, the content moderation engine 118 performs various actions to moderate the content 108 and/or the domain users 104 within the online social community platform 102. For example, the content moderation engine 118 may be tasked with flagging user-uploaded content that is offensive or hurtful (e.g., profanity, obscene images, comments that amount to online “bullying”) and/or initiate punitive actions against domain users 104 responsible for uploading the content 108.

The content moderation engine 118 includes memory 110 and a processor 120 for executing various modules stored in the memory 110, such as a content moderator 112. When executed by the processor 120, the content moderator 112 scans content of the online social community platform 102 to identify items for flagging and/or take-down based on moderator logic 136. For example, the moderator logic 136 may include a data store 138 of content items (e.g., one or more images, phrases, terms or audio or video clips previously identified as satisfying ‘reaction consensus criteria’ for various reasons) and rules 140 for determining what, if any, moderation action to take when instances of one or more of the content items from the data store 138 are identified within the content 108 of the online social community platform 102. In one implementation, the rules 140 provide for conditional actions such as automatic removal and/or flagging (e.g., flagging of content for additional review). The rules 140 may be based on one or more context or audience factors, such as a usage context in which various content items appear, demographic information about particular users able to view the content items, and geographic origins of the users able to view the content items.

Upon discovering content that is included in or associated with the data store 138, the content moderator 112 applies the moderator logic 136 to determine whether to perform a content moderation action, such as flagging the content for further review, filtering out the content based on user-defined rules, automatically taking down the content so it is no longer visible to one or more users of the domain users 104 of the online social community platform 102, and/or implementing a punitive action against the user(s) responsible for posting the content.

In an implementation where each of the domain users 104 provides an access credential to view the content 108, the content moderation engine 118 may moderate content differently between different users of the online social community platform 102. This is also referred to herein as audience-specific content moderation. For example, each user account is associated with an accessible online space, which is a subset of the online social community platform 102 that the user can access by logging into the online social community platform 102 with a personal access credential. Content available to one user may not be available to another user that is logged in to the online social community platform 102 with a different personal access credential. Audience-specific content moderation may be based on various user-specific factors, such as where each user is from, the age of the user, and other demographic factors. For example, some terms are objectionable in the United Kingdom but are not objectionable in the United States (or vice versa). Accordingly, the rules 140 may include a content moderation rule that prevents a term from appearing within accessible space of the online social community platform 102 for users residing in the United Kingdom but does not prevent the term from appearing within accessible space of the online social community platform 102 for users residing in the United States.

In another implementation, the rules 140 of the moderator logic 136 provide for moderation actions based on user demographics, such as a user's age. For example, the content moderator 112 may selectively implement a content moderation action such that an 11-year old user logged into the social community 102 with a personal account credential sees very different content than a 35-year old user from a same geographic location logged into the online social community platform 102 with a different personal account credential.

In general, the moderator logic 136 (e.g., the rules 140 and/or the data store 138) includes a trained dataset based on data collected from and/or provided by the domain users 104 in the online social community platform 102. In one implementation, the data store 138 of the moderator logic 136 includes content items that have been deemed “offensive” or “hurtful” by a subset of the domain users 104, such as content that is viewed as profane, used in online bullying, or otherwise objectionable.

A reaction feedback collection and analysis engine 116 is tasked with training the moderator logic 136 with training inputs that populate the data store 138 (e.g., with content items and associated metadata) and/or generate the rules 140 based on reaction feedback from a subset of the domain users 104 of the online social community platform 102. As used herein, “reaction feedback” refers to reactions to content (e.g., opinion data) provided by one or more domain users 104 pertaining to specific content items. For example, reaction feedback regarding a certain content item may be solicited from a group of the domain users 104 to allow for a more accurate assessment of whether those domain users believe the content item is objectionable.

Due to the dynamic and subjective nature of these training inputs (e.g., inputs based on reaction feedback), evaluations performed by the reaction feedback collection and analysis engine 116 are based on and responsive to various evolving social and community trends that change the type and/or nature of content that the domain users 104 of the online social community platform 102 perceive as objectionable. These perceptions may change over time and may be responsive to world events, popular culture, or a number of other factors. For example, popular TV shows may influence nicknames and derogatory terms that online bullies may use, and these nicknames or terms can more quickly be added to the data store 138 if the domain users 104 provide reaction feedback to enable identification of such terms. In addition, such collection and use of reaction feedback expedites effective machine learning and thereby enables quicker identification of obscene content.

The reaction feedback collection and analysis engine 116 includes memory 130 and a processor 128 for executing various modules stored in the memory 130, such as a preliminary evaluator 132, crowd-source reaction collector 122, a feedback aggregator and analyzer 124.

In one implementation, the preliminary evaluator 132 compiles a collection of user-provided content items (e.g., comments, images, audio) that satisfy a preliminary evaluation threshold. For example, a content item may satisfy a preliminary evaluation threshold if a user has complained about the content item, such as by placing an online complaint about the content item or flagging the content item through tools provided by the primary domain 134. In these cases, the reaction feedback collection and analysis engine 116 adds each of user-provided content items to a collection responsive to receipt of an associated user-initiated notification of potentially problematic content. The collection is in turn provided to the crowd-source reaction collector 122 (discussed further below).

In other implementations, the preliminary evaluation criteria are satisfied when the preliminary evaluator 132 initially identifies user-uploaded content that matches a content item included in a predetermined list of “potentially objectionable” content. In still another implementation, the preliminary evaluation criteria are satisfied when a user-uploaded content item satisfies one or more predefined rules established for flagging potentially offensive content.

The preliminary evaluator 132 provides items identified as satisfying the preliminary evaluation criteria to the crowd-source reaction collector 122 which, in turn, collects reaction feedback from the domain users 104 to facilitate a more accurate evaluation of each of the identified content items (e.g., content items initially identified as “potentially objectionable”).

The crowd-source reaction collector 122 may assume a variety of forms in different implementations. In one implementation, the crowd-source reaction collector 122 is an application provided by or developed on behalf of the primary domain 134 that the domain users 104 may download to respective personal devices. For example, the domain users 104 may download and interact with the application to provide reaction feedback on various “potentially objectionable” user-uploaded content items identified by the preliminary evaluator 132. This feedback allows the reaction feedback collection and analysis engine 116 to better assess whether items identified as satisfying the preliminary evaluation threshold are actually offensive or hurtful based on a community consensus standard.

User incentives for providing reaction feedback may vary. If the user spends a lot of time in the online social community platform 102 and is likely to be affected by words, phrases, or content that is “trending,” then a user may see a personal benefit to contributing to the online social community by assisting in content moderation via community stewardship without extrinsic or tangible incentives. In other cases, the primary domain 134 may offer an incentive to entice a user to interact with the crowd-source reaction collector 122. For example, the primary domain 134 may reward the domain users 104 that choose to provide reaction feedback, such as by providing them with access to certain ‘bonus’ features or content, “points” redeemable in some way, etc.

Reaction feedback collected by the crowd-source reaction collector 122 is provided to a feedback aggregator and analyzer 124 for data aggregation and dataset analysis to identify a subset of the content items for which the collected reaction feedback satisfies predetermined “reaction consensus criteria.” For example, the preliminary evaluation threshold is satisfied when a user initially reports a content item as “potentially objectionable” and the reaction consensus criteria are satisfied when the feedback aggregator and analyzer 124 determines that a threshold percentage of the domain users 104 react to the content item in a certain way. For some content items, the reaction consensus criteria are context-specific, meaning that a content item may satisfy the reaction consensus criteria when used in some contexts but not when used in other contexts. For example, a particular term may be non-offensive if used in comments between persons known to be “friends” in real life (e.g., as established by profile information or other criteria), but highly offensive when used between individuals who do not know each other.

The reaction consensus criteria may also be user-specific. For example, a content item may satisfy the reaction consensus criteria with respect to some end users (e.g., a very young user) but not with respect to other users (e.g., an older user).

When the feedback aggregator and analyzer 124 determines that reaction feedback for a particular content item satisfies the reaction consensus criteria, the reaction feedback collection and analysis engine 116 updates the moderator logic 136 to include logic providing for one or more conditionally-implemented moderation actions to be taken when the content item is discovered within the online social community platform 102 in the future. In some cases, the moderator logic 136 is updated to include the content item in conjunction with metadata about the content item. For example, metadata may include information pertaining to specific usage contexts in which the content item is deemed to meet the reaction consensus criteria, translations of the content item into other languages (e.g., if the content item is linguistic in nature), or associations with (e.g., pointers to) other content items known to have similarities, such as synonyms, popular misspellings of one or more words included within the content item.

In other implementations, the reaction feedback collection and analysis engine 116 implements one or more additional levels of evaluation before updating the moderator logic 136 based on the content items. For example, the reaction feedback collection and analysis engine 116 may additionally monitor a usage of content items satisfying the reaction consensus criteria within the online social community platform 102 to determine how often each of the content items is being used. If it is determined that a particular content item is used frequently and/or if there has been a recent spike the usage of a term (as sometimes is observed when a profane or bullying phrase begins to ‘catch on’ within an online social community), the moderation logic 136 is then updated to provide for one or more conditionally-implemented moderation actions pertaining to content item. Other implementations of the reaction feedback collection and analysis engine 116 may implement other evaluation thresholds in lieu of or in addition to the reaction consensus criteria and evaluation thresholds discussed herein. For example, some implementations may employ personal to manually review certain content items, such as when the above-described analysis is inconclusive.

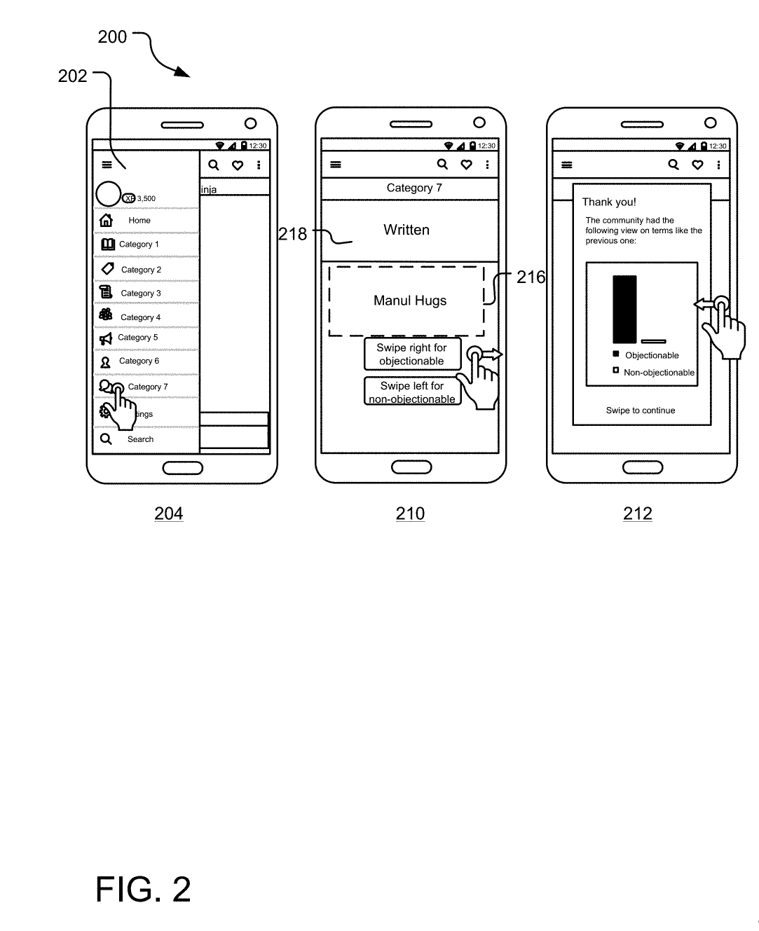

FIG. 2 illustrates an example crowd-source reaction collector 200 that presents various user interfaces for collecting reaction feedback usable to train content moderation logic. The reaction feedback reflects user reactions pertaining to particular content items appearing within an online social community platform. In one implementation, the crowd-source reaction collector performs actions the same or similar to those described with respect to the crowd-source reaction collector 122 of FIG. 1. In one implementation, the crowd-source reaction collector 200 is an application is developed by or on behalf of a primary domain that manages the online social community platform. The crowd-source reaction collector 200 collects reaction feedback from domain users and is utilized to train a content moderation logic executable to moderate content available through the online social community platform according to certain rules. For example, the crowd-source reaction collector 200 is available for download to domain users with personal accounts registered on the primary domain. In one implementation, a user downloads the application to a personal electronic device but is unable access to content of the application until he or she has provided valid access credentials for a personal account registered with the primary domain.

Various domain users may interact with the application to provide reaction feedback to different content items. In the example of FIG. 2, the crowd-source reaction collector 200 includes a menu 202 (displayed in a first user interface screen 204) that gives a user the option to selecting from a number of game-like activities. During each activity, the crowd-source reaction collector 200 presents the user with different content items and solicits information about the user's reaction to each content item. For example, the user may be prompted with a term, phrase, image, sentence, etc. and asked to indicate whether their initial reaction is positive or negative.

In the example of FIG. 2, the user selects an activity “category 7” from a drop-down menu of the application, and application presents the user with a second user interface screen 210 prompting the user to provide reaction feedback pertaining to a content item that is a phrase 216. For example, the phrase 216 may have been added to the application after a user of the online social community platform flagged the phrase 216 as objectionable.

A context bar 218 indicates a usage context in which the user is to assume the phrase 216 is used. In FIG. 2, the example usage context is “written” meaning that user is to assume that the phrase 216 appears written within text that another user has uploaded. Without logic specifically designed to evaluate the phrase 216 and/or information regarding the intent of the user who used this phrase 216, it may be difficult for an automated process to identify the phrase 216 as potentially objectionable.

The second user interface screen 210 prompts the user to “swipe right for offensive” or “swipe left for non-offensive.” Notably, some phrases provided by the crowd-source reaction collector 200 may be considered offensive within certain geographic regions and not offensive within other geographic regions. Therefore, user input for each content item may vary from one user to another user. The user swipes right to indicate that the phrase is offensive. The user is then presented with a third interface screen 212 that includes a graphical presentation of the reaction feedback collected from other users in the community to the same and/or similar content items. When the reaction feedback is subsequently analyzed to assess potential content moderation actions (e.g., to update moderator logic 136 discussed with respect to FIG. 1), it may be determined that the phrase 216 satisfies “reaction consensus criteria” because a large percentage of the domain users identified the phrase as offensive. In response to such determination, the phrase 216 may then be added to moderation vocabulary of a content moderator. For example, a data store of the content moderator may be updated to include one or more terms from the phrase 216 to enable automated identification and flagging of similar phrases within content of the online social community platform in the future. In some implementations, logic of the content moderation logic is also updated to provide for future and/or retrospective actions for users that utilize the phrase 216 or similar content within the online social community platform. For example, the moderator logic may provide for temporarily disabling one or more features of the user's account, including removal of the phrase 216 from content available through the online social community platform.

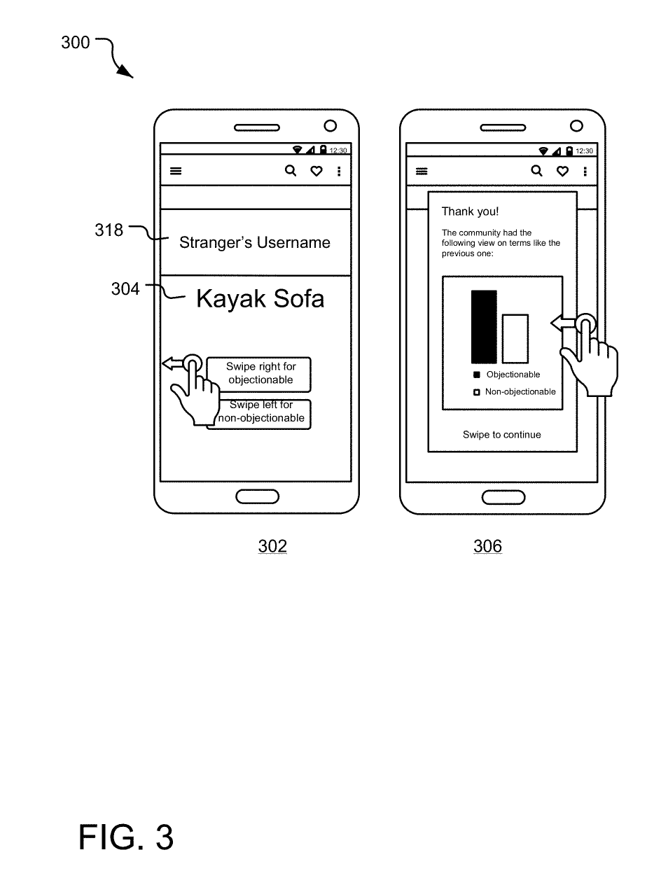

FIG. 3 illustrates example interfaces of another crowd-source reaction collector 300 for collecting reaction feedback from users pertaining to user-provided (e.g., user-uploaded) content appearing available through an online social community platform. In the example of FIG. 3, a first interface screen 302 prompts a user to provide reaction feedback pertaining to a content item 304 (“kayak sofa”). A context bar 318 indicates a usage context (“stranger's username”) in which the user of the crowd-source reaction collector 300 is to assume the content item 304 appears. Like many actual slang terms with negative connotations, the term “kayak sofa” may be a term that a user has flagged as offensive within the online social community but that a content moderation process of the online social community is not yet trained to recognize. In some cases, a term such as this may actually be offensive or hurtful. In other cases, it may be that the term was flagged in error.

Some content moderation processes employ content moderation personnel to manually evaluate each content item that is flagged by a user. This use of manual labor is inefficient and, in many cases, yields results inconsistent with the popular opinions of those primarily affected by (e.g., exposed to) the content item within the online social community. This is due to the fact that content moderation personnel may not always be aware of social connotations associated with certain content, such as trending “new” slang terms and jargon used in other countries where the content moderation may not have adequate familiarity with modern dialect.

Excessive moderation can anger users of the online social community platform, while lax moderation may offend users and encourage them to leave. To address this balance, the crowd-source reaction collector 300 allows peers within an online social community to evaluate whether the content item 304 (“kayak sofa”) has some negative social connotation likely to be found objectionable by some users.

In one implementation, the users interacting with the crowd-source reaction collector 300 each have a personal account on a primary domain that receives and analyzes the reaction feedback from the crowd-source reaction collector 300. For example, users providing the reaction feedback from the crowd-source reaction collector 300 may have personal accounts with a primary domain. By logging in to the primary domain with personal account credentials, the users can view and share content that is moderated according to rules developed based on the reaction feedback from the same users.

In FIG. 3, the first user interface screen 302 prompts the user to “swipe right for objectionable” or “swipe left for non-objectionable.” The user swipes right to indicate that the phrase is objectionable. The user is then presented with a second user interface screen 306 that includes a graphical presentation of the reaction feedback collected from other users in the community to the same content item with that same associated context 318. This graphical presentation essentially reflects a “community consensus” of reaction feedback from responding individuals. Subsequently, this collected reaction feedback pertaining to the term “kayak sofa” may be further analyzed to generate one or more rules to be added to content moderation logic in association with the content item 304.

Although not shown in FIG. 3, the crowd-source reaction collector 300 may save the collected reaction feedback for the content item 304 in association with profile data from each responding user. For example, a user may interact with the crowd-source reaction collector 300 after logging into a personal account, and associated personal account profile data (e.g., age, geographic location) may be automatically saved in association with reaction feedback collected from each individual user. Such information may allow subsequent analysis of the reaction feedback to account for regional and demographic influences on the collected reaction feedback.

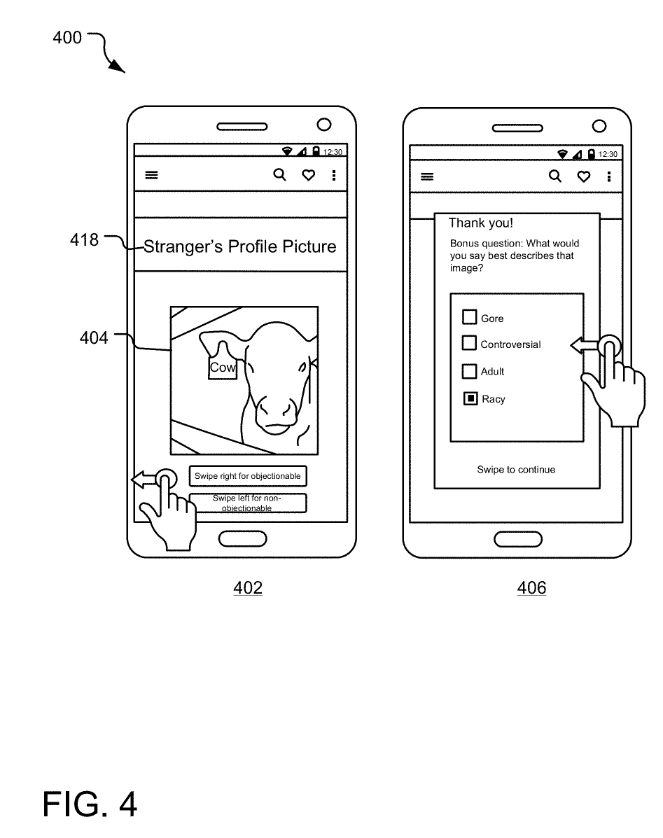

FIG. 4 illustrates example interfaces of crowd-source reaction collector 400 for collecting reaction feedback from users pertaining to content appearing within an online social community platform. In one implementation, the online social community includes a primary domain that manages one or more websites that allow allows users to upload and share content. These users provide reaction feedback to various content items via the crowd-source reaction collector 400, and content moderation logic used to moderate content within the online social community platform is trained based on an assessment of this reaction feedback.

In the example of FIG. 4, a first interface screen 402 prompts a user to provide reaction feedback pertaining to a content item 404 that is an image of a cow. A content bar 418 indicates a usage context in which the user of the crowd-source reaction collector 400 is to assume the content item 404 appears within the online social community platform. In FIG. 4, the example usage context is a user's profile picture.

The first user interface screen 402 prompts a user of the application to swipe left to indicate that the content item 404 is non-objectionable or swipe right to indicate that the content item 404 is objectionable. The user swipes left and is then presented with a second user interface screen 406 asking the user to provide additional information describing the content item 404. Specifically, the second user interface screen 406 asks the user to indicate one or more words further describing the content item 404. In other implementations, the crowd-source reaction collector 400 may collect reaction feedback pertaining to other types of content items in addition to words, phrases, and images. For example, the user may be asked to watch a short video clip or listen to a short sound clip and provide reaction feedback in a manner the same or similar to that discussed above.

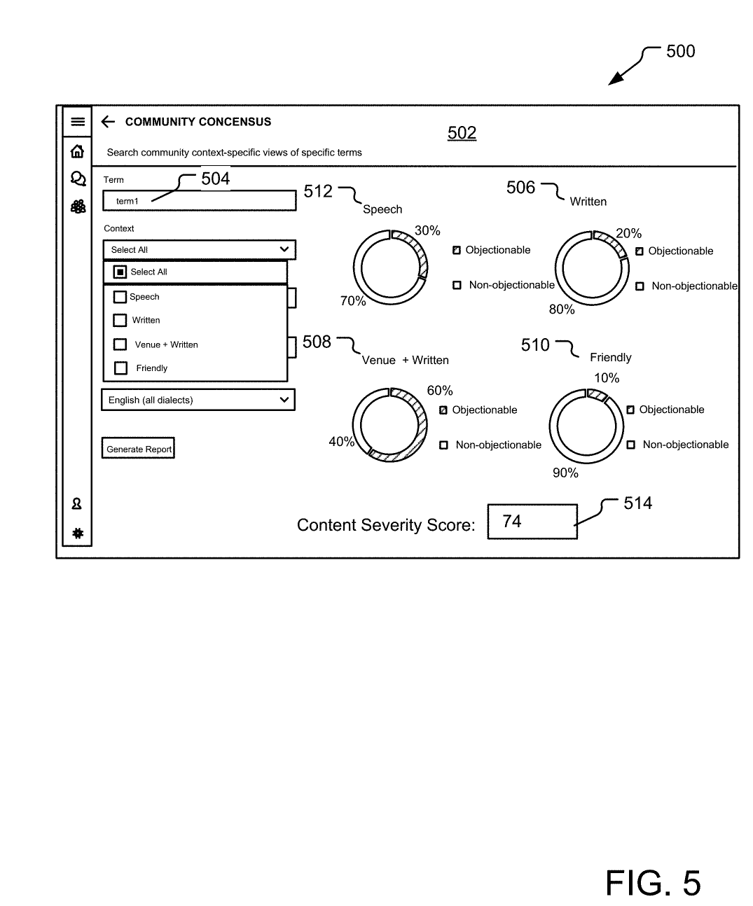

The crowd-source reaction collector 400 saves the collected reaction feedback (e.g., the objectionable/non-objectionable response and the selected descriptive terms), and provides this information to a feedback aggregator and analyzer (not shown), such as the feedback aggregator and analyzer that discussed below with respect to FIG. 5.

FIG. 5 illustrates an interface screen 502 of a feedback aggregator and analyzer 500 usable to generate training inputs for a content moderator. The interface screen 502 displays statistics pertaining to reaction feedback collected from domain users of a primary domain that relies on the content moderator to ensure content available through the primary domain meets a certain quality standard (e.g., the content is not offensive or hurtful to a large number of domain users). For example, the reaction feedback may be data initially collected by the crowd-source reaction collector 122 of FIG. 1 (e.g., via an application interface such as the examples provided in FIG. 2-4), and the information shown in the interface screen 502 is generated by the feedback aggregator and analyzer 124 described with respect to FIG. 1.

The interface screen 502 presents various statistics that reflect a community assessment of various content items usable to train a content moderation system to implement content moderation actions (e.g., flagging and/or removal) that are based on what the community or “domain users” of an online social community platform collectively think or feel. In the illustrated example, the interface screen 502 displays a community consensus statistic associated with each of four different usage contexts 506, 508, 510, and 512 of a content item 504 (e.g., “term1,” which may be a misspelled profanity). For example, 30% of users providing reaction feedback reported that they find the content item 504 objectionable when it is used in speech, such as when two remote users are engaged in live voice chat. Additionally, 20% reported that they find the content item 504 objectionable when it is written, such as when it is written in comments viewable within the online social community platform. Further, 60% reported that they found the content item 504 offensive when used in a particular venue, such as a specific online feature of activity. Further still, 10% of the users reported that the content item 504 was offensive between friends (e.g., individuals that personally know one another).

The usage contexts 506, 508, 510 and 512 are merely exemplary, and other implementations of the disclosed technology may solicit reaction feedback with respect to other usage contexts in addition to or in lieu of those shown. In some implementations, the feedback aggregator and analyzer 500 provides a more detailed statistical analysis of the collected reaction feedback with respect to different user-specific characteristics such as reaction feedback summarized based on geographical location of responding users (e.g., Australia v. the United Kingdom v. the United States), age of responding users, or any other collectable demographic. For example, collectable demographic information may be voluntarily provided by users upon when a personal account is initially set-up on the online social community platform.

Context-specific reaction feedback assessments, such as the data shown in the interface screen 502, may be utilized in different ways. In one implementation, a content moderation system evaluates this community consensus data to determine whether each assessed content item satisfies “reaction consensus criteria.” Reaction consensus criteria may, for example, include pre-established criteria based on one or more factors such as uniformity of community consensus (e.g., whether a threshold number of users agree a content item is objectionable), usage context such as the usage contexts 506, 508, 510 and 512 (e.g., whether a threshold number of users agree a content item is objectionable when it appears in a specific usage context), regional considerations (e.g., whether a threshold number of users from a same geographic location agree a content item is objectionable), and user demographic considerations (e.g., whether reaction feedback indicates that a content item is more objectionable for a certain user demographic than others).

In some implementations, the feedback analyzer and aggregator 500 may provide a content severity score 514. For example, the content severity score may represent how objectionable a term is overall, such as based on a mathematical metric taking into a number of factors, such as the percentage of users that found the term 504 objectionable in each of the different contexts 506, 508, 510, and 512. This scoring could be used in different ways, such as in determining how severe of a punitive measure to impose on a particular user that uses the term 504 within the online social community platform. In one implementation, the value of the content severity score 514 determines an automated moderation action that is implemented with respect to the term 504, such as automatic removal of the term 504 or auto-flagging of the term 504 for additional review (e.g., manual review or a watch list monitored in some other way).

In one implementation, the content item 504 is used as a training input to a content moderator responsive to a determination that the reaction feedback satisfies reaction consensus criteria. For example, the content item and associated feedback data (e.g., user profile data, reaction feedback pertaining to usage contexts, and other user-provided information) may be used in modify logic of a content moderator to facilitate automated content moderation actions responsive to future instances of identical or similar content items appearing within the online social community platform.

The interface screen 502 is one example of a feedback aggregator and analyzer that happens to provide a tool to allows individuals (e.g., content moderation teams) to graphically view collected reaction feedback. In some implementations, these individuals may generate content moderation rules and update content moderator logic based on the analyzed reaction feedback presented by the feedback aggregator and analyzer 500. In other implementations, the feedback aggregator and analyzer 500 generates rules and/or updates content moderation logic to include such new rules without human intervention. For example, a rule may be automatically generated and added to content moderation logic whenever reaction feedback satisfies a set of predefined reaction consensus criteria (e.g., a threshold percentage of responding users find a term to be offensive; a threshold percentage of responding users find the term to be offensive when used in a particular context; a threshold percentage of responding users from a same geographic locale find the content item (e.g., a term, imagery) to be offensive).

Reaction consensus criteria satisfaction may be context-specific. If, for example, the content item 504 item satisfies the reaction consensus criteria for each of the usage contexts 506, 508, 510 and 512, the feedback aggregator and analyzer 500 may automatically generate a rule that provides for an action (e.g., flagging or removal) responsive to any future identified instances of the content item 504. This rule may then be automatically added to content moderation logic for use in content moderation. Alternatively, if the content item 504 satisfies the reaction consensus criteria for one usage context but not for another usage context, logic of a content moderator may be adapted for usage-specific (e.g., conditional) content moderation, such as via generation of a rule that provides for an automated moderation action responsive to future instances of the content item 504 corresponding to one or more specific usage contexts for which the reaction consensus criteria is satisfied. For example, the new rule may provide for flagging and/or removal of content including the term if the content utilizes the term in a certain usage context (e.g., the term appears from a stranger) while permitting the same term to appear in another usage context (e.g., in comments made between users that identify one another as ‘friends’ within the online social community platform).

Some implementations of the disclosed technology are agnostic toward usage context in evaluating each content item. For example, the feedback aggregator and analyzer 500 may exclusively consider an overall “positive or negative” community consensus in determining whether a particular content item satisfies reaction consensus criteria. In one implementation, reaction consensus criteria are satisfied for a content item if some predetermined threshold (e.g., 60%) of responding users indicate that the content item is offensive in at least one usage context.

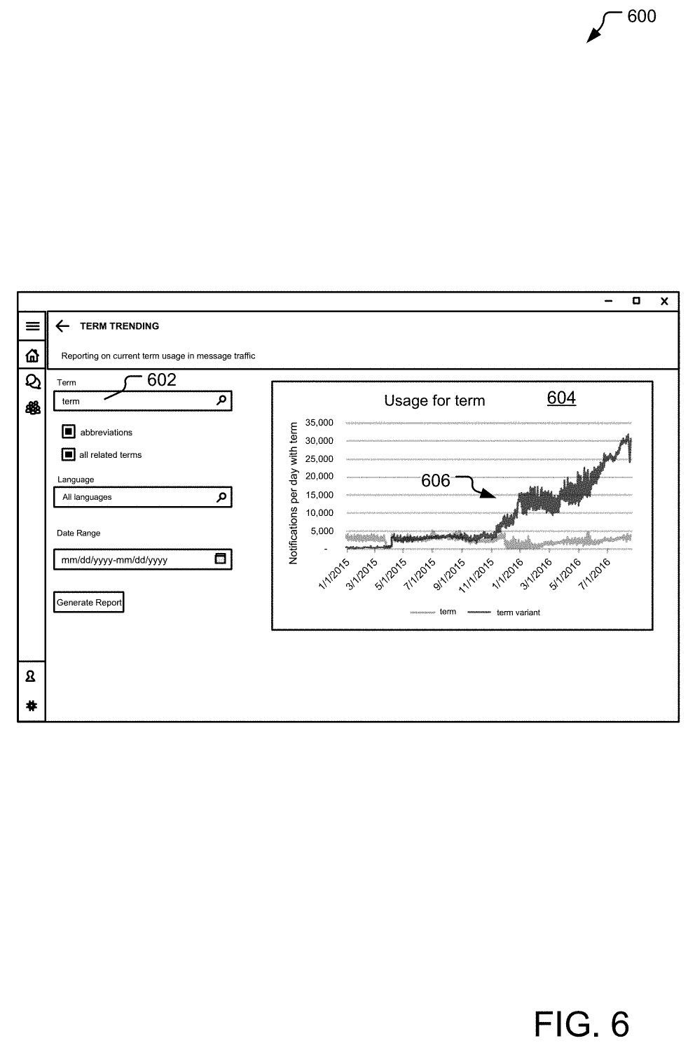

In still other implementations, satisfaction of the reaction consensus criteria does not result in immediate modification of logic of a content moderator. Rather, a content item satisfying reaction consensus criteria may be evaluated based on one or more additional factors, such as by tracking the “usage frequency” as discussed below with respect to FIG. 6.

FIG. 6 illustrates example user interface 600 showing a plot 604 of frequency usage for a content item (e.g., a term 602) within an online social community platform. Data shown on the plot 604 is collected by a content moderation system.

In one implementation, the term 602 was previously-identified as satisfying “reaction consensus criteria,” and the content moderation system began monitoring a usage of the term 602 within the online social community platform. As shown by the plot 604, a significant increase 606 in usage of the term 602 and term variants (e.g., related or equivalent terms) is observed between November and July of 2015. This ‘usage spike’ scenario is characteristic of the situation where a popularized related term to a known objectionable term sees a steep increase in usage (e.g., a popular new misspelling of a known profanity). Tracking usage frequency in this manner helps to confirm that the term 602 is worth pursuing (e.g., actively seeking out for flagging and/or removed) in an automated content moderation process because the term is now prevalent enough that a large number of users of the online community platform are likely to encounter the term 602.

Once an increase in usage frequency of a threshold magnitude is observed (such as the significant increase 606) logic of a content moderator may then be modified to provide for one or more actions taken with respect to the term 602. In different implementations, various content moderation systems implementing the disclosed technology may monitor usage frequency statistics for different trends and thresholds.

This approach may be particularly useful in implementations seeking to balance the competing objectives of reduced processing in content moderation while still automatically training a content moderator to moderate the most prevalent types of objectionable (e.g., the content items that satisfy the reaction consensus criteria that are growing in popularity within the online social community platform).

In one implementation, the example user interface 600 is generated by a reaction feedback and analysis engine responsive to (1) a determination that the term 602 satisfies a preliminary evaluation threshold (e.g., was flagged by a user of an online social community as potentially offensive); (2) a collection of reaction feedback regarding the term 602 from various users of the online social community; and (3) a determination that the term 602 satisfies reaction consensus criteria based on an assessment of the collected reaction feedback.

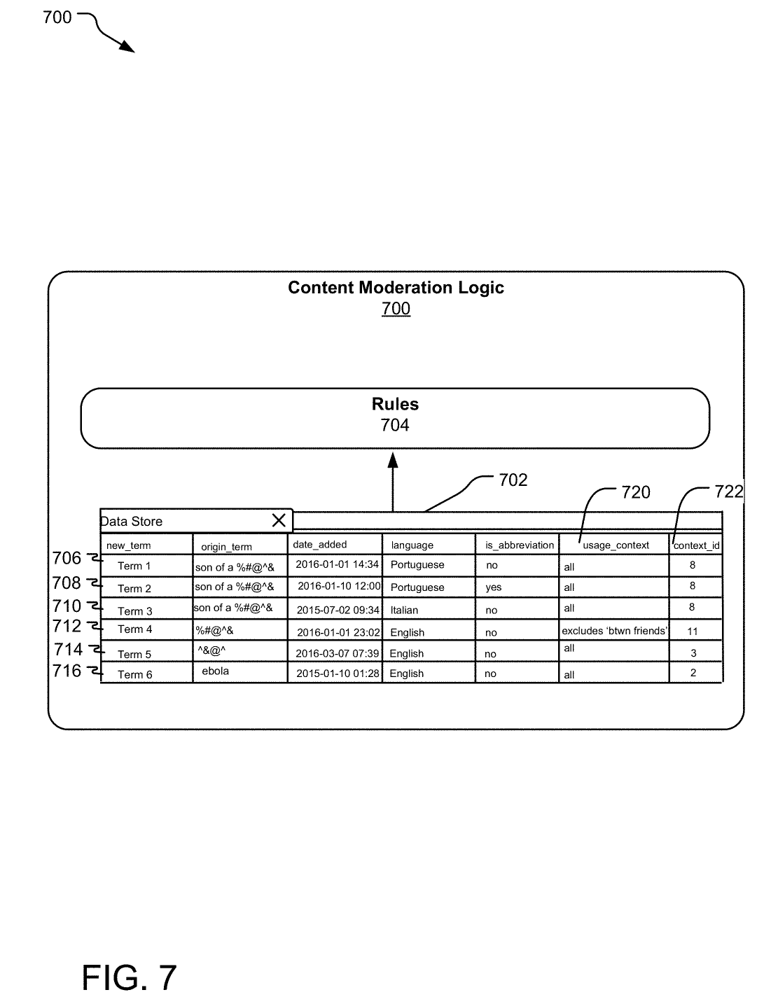

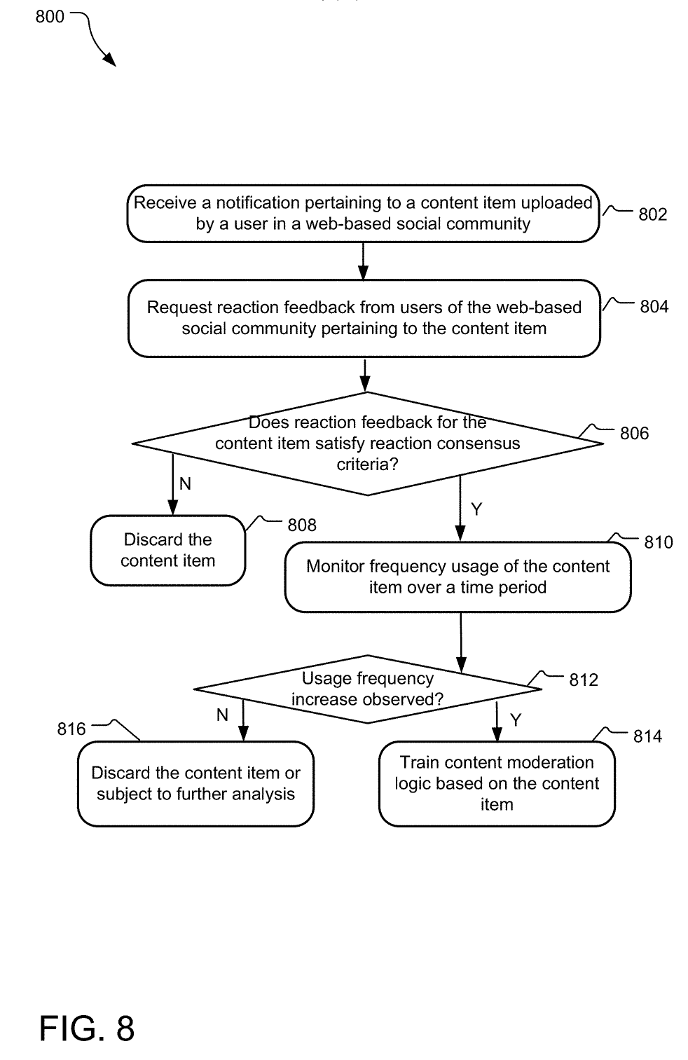

FIG. 7 illustrates an example moderator logic 700 of a content moderation system usable to moderate content in an online social community. The moderator logic 700 includes a data store 702 and rules 704 for selectively implementing moderation actions with respect to content within the online social community platform. In one implementation, each item in the data store 702 was added responsive to receipt and analysis of user feedback (e.g., reaction feedback) from users. For example, reaction feedback was collected with respect to each term in the data store 702, and each term was added to the data store 702 responsive to analysis of the reaction feedback indicating satisfaction of certain criteria (e.g., majority of the domain users understood the term as being strongly objectionable).

In FIG. 7, the data store 702 is a data store table including terms (e.g., terms 706, 708, 710, 712, 714, and 716); however, other implementations of the data store 702 may include full phrases, sentences, images, audio clips, etc. In different implementations, the data store 702 may include different information, such as information collected in association with reaction feedback, determined based on reaction feedback, and supplemental information associated with each content item retrieved from other resources. In FIG. 7, each of the terms 706, 708, 710, 712, 714, and 716 may, for example, represent slang words deemed objectionable in a previous analysis, such as misspelled profanities. Each of these terms is associated with a known origin term (e.g., the corresponding profanities with correct spelling), which is replaced in whole or in part by symbols (e.g., %#@̂&, ŝ$#) for the example shown. For example, the terms 706 and 710 are Portuguese and Italian translations of the corresponding origin term (e.g., “son of a %#@̂&”). The term 708 is an abbreviation (as indicated by a column “is_abbreviation”) of the Italian translation of this same origin term. The terms 712 and 714 are popular misspellings of other profane or objectionable origin terms in the English language. The data store 702 may include a variety of other terms representing translations of each data store term into different languages.

The data store 702 also includes metadata related to each context item. For example, a usage context field 720 indicates one or more usage contexts for which an item in the data store 702 has been identified as satisfying reaction consensus criteria. For most items in the data store 702, the usage context field 720 indicates “all,” meaning that the associated reaction feedback satisfied reaction consensus criteria in all examined usage contexts. However, the usage context field 720 for the term 712 reads “excludes ‘btwn “friends,”’ indicating that reaction feedback for the term 712 satisfies the reaction consensus criteria in all examined usage contexts except for a usage context “between friends” (e.g., users believe the term 712 is not objectionable when used between friends but that the term 712 is objectionable in all other examined contexts). The data store 702 further includes a context descriptor field 722 providing a numerical classifier corresponding to a particular descriptor (e.g., sensitive, controversial) associated with each term. The context descriptor field 722 may be based on collected reaction feedback or determined by other means.

In one implementation, the data store 702 is populated automatically by the content moderation system responsive to analysis and receipt of reaction feedback (e.g., as described with respect to FIGS. 1-6). In some implementations, one or more fields of the data store 702 are updated manually.

When the content moderator identifies an instance of a content item in the online community that matches a content item (e.g., a term) within the data store 702, the content moderator assesses moderation actions based on the rules 704 associated with the various content items and associated metadata in the data store 702. According to one implementation, the rules 704 are developed based on reaction feedback (e.g., as reflected by one or more fields in association with each term in the data store 702) and user data such as user profile data, user demographic data, etc. For example, one rule might provide for flagging or removal of content items unless the content moderator can determine that the content items (e.g., comments, messages, images etc.) represent exchanges between ‘friends’ (e.g., two persons who have user accounts that identify one another as ‘friends’).

Content moderation actions may be universal (e.g., affecting all domain users equally) or audience-specific. For example, content that a domain user can see when logged into a personal account with a primary domain of the online social community may be moderated based on profile information associated with his or her account. For example, a rule may provide for removal of content items that are associated with the language “Portuguese” in the data store 702 from accessible web space in the online social community of domain users that reside in Portugal or countries that primarily speak Portuguese. In this case, the content moderator censors the terms 706 (“term1”) and 708 (“term2”) from visibility of user accounts associated with these countries, but not from visibility of user accounts associated with other, non-Portuguese speaking countries. Still another example rule might provide for flagging or removal of a content item from accessible web space of users most likely to find that content item objectionable. For example, the data store 702 may include a field indicating a demographic of users (e.g., geographical location, age) that find an associated term to be objectionable. One of the rules 704 can then provide for selective flagging or removal of the term with respect to accessible webspace of users of a same demographic. For example, the data store 702 may indicate that a given term is objectionable to users residing in Great Britain but not objectionable to users in the United States. In this case, a rule may provide for flagging or removal of the term with respect to webspace accessible by users residing in Great Britain but not in the United States.

In still other implementations, one or more of the rules 704 provide for selective censoring of one or more of the terms in the data store 702 from accounts associated with users satisfying a certain demographic, such as a “youth” demographic.

In still other implementations, the content moderator logic provides for moderation actions other than automated removal, such as flagging (e.g., marking for further review, such as by content moderation personnel), or actions against domain users responsible for uploading content including one or more terms or other content items from the data store 702. For example, the content moderation system may revoke the user's access to certain features available in the online social community platform.

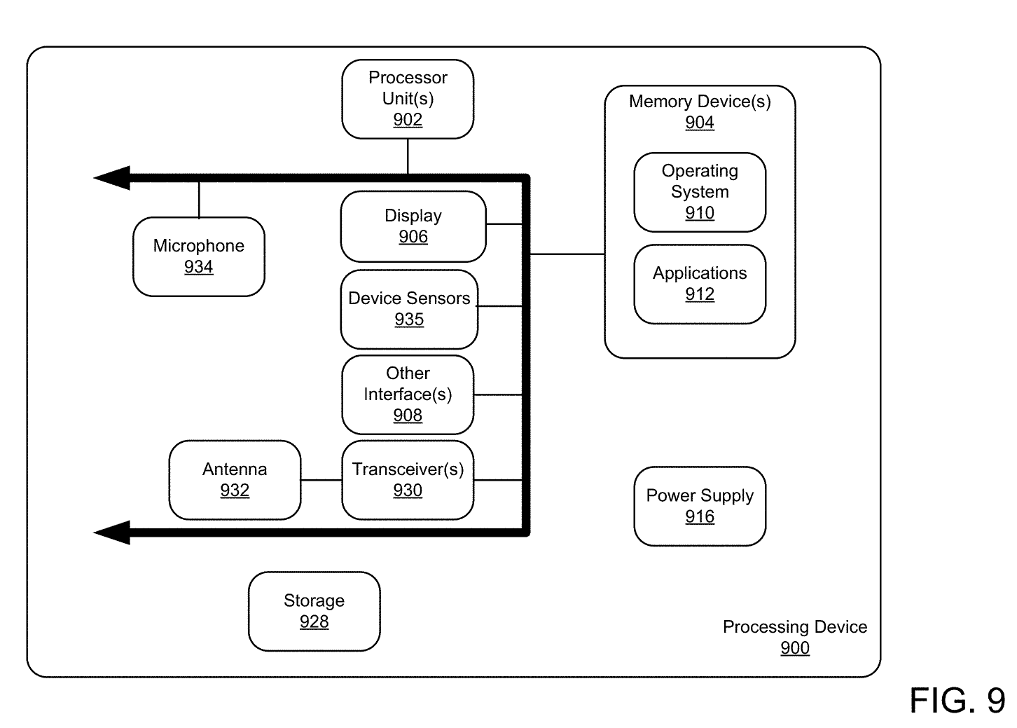

FIG. 8 illustrates example operations 800 for escalating machine-learning selection of a vocabulary of moderated terms for content moderation. A receiving operation 802 receives a notification pertaining to user-uploaded content available within an online social community platform. For example, the notification may initially flag the user-uploaded content item as objectionable. The notification may be triggered when, for example, a user places a complaint pertaining to the user-uploaded content item or uses a tool to flag the user-uploaded content item as objectionable.

A requesting operation 802 requests reaction feedback from users of the online social community platform pertaining to the content item. For example, the requesting operation 802 may solicit reaction feedback from various users of the online social community pertaining to the content item in a manner the same or similar to the examples described in FIGS. 2-4. A determination operation 806 then determines whether the reaction feedback collected with respect to the select content item satisfies reaction consensus criteria.

In one implementation, the reaction consensus criteria include a set of predefined rules governing whether or not the content item is to be discarded or remain under consideration for use as a training input to a content moderator. For example, the determination operation 806 may entail aggregating and analyzing large data sets of collected reaction feedback and assessing whether statistical representations of the analyzed datasets satisfy the reaction consensus criteria. In one implementation, reaction consensus criteria is based on a community consensus standard and defines a threshold percentage of users that find the content item to be offensive. For example, reaction consensus criteria may be satisfied when a predetermined percentage of responding users indicate that the content item is offensive, or when a predetermined percentage of users of a certain demographic indicate that the content item is offensive.

In some implementations, a content item is automatically used as a training input to a content moderator when the determination operation 806 determines that associated reaction feedback satisfies reaction consensus criteria. In the implementation of FIG. 8, content items with reaction feedback satisfying reaction consensus criteria are subjected to additional analysis before being used to form training inputs for a content moderator.

If the reaction feedback for the selected content item does not satisfy the reaction consensus criteria, a discarding operation 808 discards the content from consideration as a potential training input for a content moderator. If, however, the reaction feedback for the selected content item does satisfy the reaction consensus criteria, a monitoring operation 810 begins monitoring a frequency with which the term is used in the online social community platform over a set interval. For example, the monitoring operation 810 may track the number and frequency of new instances of the content item over a set time interval.

A determining operation 812 determines whether a usage frequency increase is observed in the data collected by the monitoring operation 810. If, for example, a sudden increase in usage frequency is observed in excess of a set threshold, such an increase may indicate that the content item is gaining popularity and beginning to affect many users of the online community.

If a high enough increase in usage frequency of the content item is not observed during the interval set for monitoring, a termination operation 816 terminates the monitoring of the content item. The content item may be discarded or, in some cases, subjected to additional analysis. If, however, the determination operation 812 determines that there is a usage frequency spike of a predetermined threshold for the content item, a training operation 814 uses the content item as an input to content moderator. For example, the content item may be added to a vocabulary used in content moderation and one or more rules may be implemented for future moderation actions taken with respect to new instances of the content item within the online social community.

FIG. 9 illustrates an example schematic of a processing device 900 suitable for implementing aspects of a content moderation system. The processing device 900 includes one or more processing unit(s) 902, one or more memory 904, a display 906, and other interfaces 908 (e.g., buttons). The memory 904 generally includes both volatile memory (e.g., RAM) and non-volatile memory (e.g., flash memory). An operating system 910, such as the Microsoft Windows® operating system, the Microsoft Windows® Phone operating system or a specific operating system designed for a gaming device, resides in the memory 904 and is executed by the processing unit(s) 902, although it should be understood that other operating systems may be employed.

One or more applications 912, such as a preliminary evaluator, crowd-source reaction collector, feedback aggregator and analyzer, or content moderator are loaded in the memory 904 and executed on the operating system 910 by the processing unit(s) 902. The applications 912 may receive input from the display 906 and/or device sensors 935, such as touch sensors embedded within or beneath the display 906. The processing device 900 includes a power supply 916, which is powered by one or more batteries or other power sources and which provides power to other components of the processing device 900. The power supply 916 may also be connected to an external power source that overrides or recharges the built-in batteries or other power sources.

The processing device 900 includes one or more communication transceivers 930 and an antenna 932 to provide network connectivity (e.g., a mobile phone network, Wi-Fi®, BlueTooth®, etc.). The processing device 900 may also include various other components, such as a positioning system (e.g., a global positioning satellite transceiver), one or more accelerometers, one or more cameras, an audio interface (e.g., a microphone 934, an audio amplifier and speaker and/or audio jack), and storage devices 928. Other configurations may also be employed.

In an example implementation, a mobile operating system, various applications (including a stylus position detection engine) and other modules and services may be embodied by instructions stored in memory 904 and/or storage devices 928 and processed by the processing unit(s) 902. The memory 904 may be memory of host device or of an accessory that couples to a host.

The processing device 900 may include a variety of tangible computer-readable storage media and intangible computer-readable communication signals. Tangible computer-readable storage can be embodied by any available media that can be accessed by the processing device 900 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 900. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example method for escalating machine-learning selection of content of moderated terms for content moderation includes requesting reaction feedback from users of an online social community platform in association with each of a number of user-provided content items appearing in the online social community platform. The method further provides for analyzing the reaction feedback from the users of the online social community platform with respect to each of the user-provided content items to identify a subset of the user-provided content items satisfying reaction consensus criteria; training content moderation logic based on the subset of content items identified from the analysis of the reaction feedback; and selectively performing a content moderation action based on the trained content moderation logic.

Another example method of any preceding method includes receiving a notification of potentially objectionable content in association with each one of the user-provided content items and requesting the reaction feedback from the users responsive to the receipt of notification of the potentially objectionable content.

In another example method of any preceding method, each of the users of the online social community platform is granted access to content in the online social community responsive to authentication of a personal account credential and the reaction feedback is solicited from a user in association with the user's respective personal account credential.

In another example method of any preceding method, the method further includes updating a moderation data store to include a content item and at least one associated usage context in which the content item is identified as satisfying the reaction consensus criteria and updating the content moderation logic to provide for performance of a content moderation action responsive to identification of an instance of the content item appearing in a context matching the at least one associated usage context.

In another example method of any preceding method, the method further includes analyzing the reaction feedback from users of the online social community platform to identify a geographic source of a subset of the reaction feedback satisfying the reaction consensus criteria for a select content item, and updating a moderation data store to associate the geographic source with the select content item.

In another example method of any preceding method, the method further includes identifying an instance of the select content item within the online social community platform and selectively removing the instance of the select content item from accessible online space of a subset of the users residing in a geographic location corresponding to the geographic source while permitting the instance of the content item to remain within accessible online space of a subset of the users residing in other geographic locations.

In another example method of any preceding method, the method includes periodically scanning content in the online social community platform to track usage frequency of the content items satisfying the reaction consensus criteria; detecting an increase in the usage frequency of a first content item of the content items satisfying the reaction consensus criteria, the increase in the usage frequency satisfying a threshold; and responsive to the detected increase in the usage frequency, training the content moderation logic to automatically perform a content moderation action on content including the first content item within the online social community platform.

In another example method of any preceding method, the method includes automatically flagging content for further review.

An example content moderation system includes a reaction feedback collection and analysis engine stored in memory and executable by a processor to solicit reaction feedback from users of an online social community platform in association with each of a number of user-provided content items appearing in the online social community platform; analyze the reaction feedback from the users of the online social community platform with respect to each of the user-provided content items to identify a subset of the user-provided content items satisfying reaction consensus criteria; and train content moderation logic based on the subset of content items identified from the analysis of the reaction feedback. The system further includes a content moderation engine stored in memory and executable by a processor to selectively perform a content moderation action based on the trained content moderation logic.

In an example system of any preceding system, the reaction feedback collection and analysis engine is further configured to receive a notification of potentially objectionable content in association with each one of the user-provided content items and request the reaction feedback from the users responsive to the receipt of notification of the potentially objectionable content.

In another example system of any preceding system, each of the users of the online social community platform is granted access to content in the online social community platform responsive to authentication of a personal account credential and reaction feedback is solicited from a user in association with the personal account credential of the user.

In another example system of any preceding system, the reaction feedback collection and analysis engine is further configured to update a data store to include a content tem and at least one associated usage context in which the content item is identified as satisfying the reaction consensus criteria and also configured to update the content moderation logic to provide for performance of a content moderation action responsive to identification of an instance of the content item appearing in a context matching the at least one associated usage context.

In another example system of any preceding system, the reaction feedback collection and analysis engine is further configured to analyze the reaction feedback from users of the online social community platform by identifying a geographic source of a subset of the reaction feedback satisfying the reaction consensus criteria for a select content item and train the content moderation logic by updating a moderation data store to associate the geographic source in memory with the select content item.

In another example system of any preceding system, the reaction feedback collection and analysis engine is further configured to identify an instance of the select content item within the online social community platform and selectively remove the instance of the select content item from accessible online space of a subset of the users residing in a geographic location corresponding to the geographic source while permitting the instance of the select content item to remain within accessible online space of a subset of the users residing in other geographic locations.

In still another example system of any preceding system, the reaction feedback collection and analysis engine is further configured to scan content in the online social community platform to track a usage frequency of the content items identified as satisfying the reaction consensus criteria; detect an increase in the usage frequency of a first content item of the content items identified as satisfying the reaction consensus criteria, the increase in the usage frequency satisfying a threshold; and responsive to the detected increase in the usage frequency, train the content moderation logic to flag and/or remove from the online social community platform content including the first content item.

In still another example system of any preceding system, the feedback collection and analysis engine is further configured to selectively perform the content moderation action by automatically flagging content for potential removal.

One or more processor-readable storage media of a tangible article of manufacture encodes computer-executable instructions for executing on a computer system an example computer process comprising: receiving reaction feedback from users of an online social community platform in association with each of a number of user-provided content items appearing in the online social community platform, the reaction feedback from each of the users associated with a personal access credential to a primary domain managing the online social community platform; analyzing the reaction feedback from the users of the online social community platform with respect to each of the user-provided content items to identify a subset of the user-provided content items satisfying reaction consensus criteria; training content moderation logic based on the subset of content items identified from the analysis of the reaction feedback; and selectively performing a content moderation action based on the trained content moderation logic.

An example computer process of any preceding computer process further includes selectively performing the content moderation action responsive to identification of one or more content items of the identified subset within the online social community platform.

Another example computer process of any preceding computer process further includes removing an instance of one or more content items of the identified subset from accessible online space of at least one of the users of the online social community platform.

In another example computer process of any preceding computer process, the content moderation action includes an action directed toward a user responsible for uploading an instance of one or more content items of the identified subset to the online social community platform.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A method for escalating machine-learning selection of content of moderated terms for content moderation, the method comprising:
requesting reaction feedback from users of an online social community platform in association with each of a number of user-provided content items appearing in the online social community platform;
analyzing the reaction feedback from the users of the online social community platform with respect to each of the user-provided content items to identify a subset of the user-provided content items satisfying reaction consensus criteria;
training content moderation logic based on the subset of content items identified from the analysis of the reaction feedback; and
selectively performing a content moderation action based on the trained content moderation logic.

2. The method of claim 1, further comprising:
receiving a notification of potentially objectionable content in association with each one of the user-provided content items; and
requesting the reaction feedback from the users responsive to the receipt of notification of the potentially objectionable content.

3. The method of claim 1, wherein each of the users of the online social community platform is granted access to content of the online social community platform responsive to authentication of a personal account credential and wherein soliciting the reaction feedback further comprises soliciting the reaction feedback from a user in association with the personal account credential of the user.

4. The method of claim 1, wherein training the content moderation logic further comprises:
updating a moderation data store to include an item and at least one associated usage context in which the item is identified as satisfying the reaction consensus criteria; and
updating the content moderation logic to provide for performance of a content moderation action responsive to identification of an instance of the item appearing in a context matching the at least one associated usage context.

5. The method of claim 1, wherein analyzing the reaction feedback from users of the online social community platform further comprises identifying a geographic source of a subset of the reaction feedback, the subset of the reaction feedback satisfying the reaction consensus criteria for a select content item;
and wherein training the content moderation logic further comprises updating a moderation data store to associate the geographic source with the select content item.

6. The method of claim 5 wherein the method further comprises:
identifying an instance of the select content item within the online social community platform; and
selectively removing the instance of the select content item from accessible online space of a subset of the users residing in a geographic location corresponding to the geographic source while permitting the instance of the content item to remain within accessible online space of a subset of the users residing in other geographic locations.

7. The method of claim 1, further comprising:
periodically scanning content in the online social community platform to track usage frequency of the content items satisfying the reaction consensus criteria;
detecting an increase in the usage frequency of a first content item of the content items satisfying the reaction consensus criteria, the increase in the usage frequency satisfying a threshold; and
responsive to the detected increase in the usage frequency, training the content moderation logic to automatically perform a content moderation action on content including the first content item in the online social community platform.

8. The method of claim 1, wherein selectively performing a content moderation further comprises:
automatically flagging content for further review.

9. A content moderation system comprising:
a reaction feedback collection and analysis engine stored in memory and executable by a processor to:
solicit reaction feedback from users of an online social community platform in association with each of a number of user-provided content items appearing in the online social community platform;
analyze the reaction feedback from the users of the online social community platform with respect to each of the user-provided content items to identify a subset of the user-provided content items satisfying reaction consensus criteria;
train content moderation logic based on the subset of content items identified from the analysis of the reaction feedback; and
a content moderation engine stored in memory and executable by a processor to selectively perform a content moderation action based on the trained content moderation logic.

10. The content moderation system of claim 9, wherein the reaction feedback collection and analysis engine is further configured to:
receive a notification of potentially objectionable content in association with each one of the user-provided content items; and
request the reaction feedback from the users responsive to the receipt of notification of the potentially objectionable content.

11. The content moderation system of claim 9, wherein each of the users of the online social community platform is granted access to content in the online social community platform responsive to authentication of a personal account credential and wherein soliciting the reaction feedback further comprises soliciting the reaction feedback from a user in association with the personal account credential of the user.

12. The content moderation system of claim 9, wherein the reaction feedback collection and analysis engine is further configured to:
update a data store to include a content item and at least one associated usage context in which the content item is identified as satisfying the reaction consensus criteria; and
update the content moderation logic to provide for performance of a content moderation action responsive to identification of an instance of the content item appearing in a context matching the at least one associated usage context.

13. The content moderation system of claim 9, the reaction feedback collection and analysis engine is further configured to:
analyze the reaction feedback from users of the online social community platform by identifying a geographic source of a subset of the reaction feedback, the subset of the reaction feedback satisfying the reaction consensus criteria for a select content item; and
train the content moderation logic by updating a moderation data store to associate the geographic source in memory with the select content item.

14. The content moderation system of claim 13, wherein the reaction feedback collection and analysis engine is further configured to:
identify an instance of the select content item within the online social community platform; and
selectively remove the instance of the select content item from accessible online space of a subset of the users residing in a geographic location corresponding to the geographic source while permitting the instance of the select content item to remain within accessible online space of a subset of the users residing in other geographic locations.

15. The content moderation system of claim 9, wherein the reaction feedback collection and analysis engine is further configured to:
scan content in the online social community platform to track a usage frequency of the content items identified as satisfying the reaction consensus criteria;
detect an increase in the usage frequency of a first content item of the content items identified as satisfying the reaction consensus criteria, the increase in the usage frequency satisfying a threshold; and
responsive to the detected increase in the usage frequency, train the content moderation logic to remove from the online social community platform content including the first content item.

16. The content moderation system of claim 9, wherein feedback collection and analysis engine is further configured to selectively perform the content moderation action by automatically removing content from accessible online space of one or more users of the online social community platform.

17. One or more processor-readable storage media of a tangible article of manufacture encoding computer-executable instructions for executing on a computer system a computer process, the computer process comprising:
receiving reaction feedback from users of an online social community platform in association with each of a number of user-provided content items appearing in the online social community platform, the reaction feedback from each of the users associated with a personal access credential to a primary domain managing the online social community platform;
analyzing the reaction feedback from the users of the online social community platform with respect to each of the user-provided content items to identify a subset of the user-provided content items satisfying reaction consensus criteria;
training content moderation logic based on the subset of content items identified from the analysis of the reaction feedback; and
selectively performing a content moderation action based on the trained content moderation logic.

18. The one or more processor-readable storage media of claim 17, wherein selectively performing the content moderation action further comprises
selectively performing the content moderation action responsive to identification of one or more content items of the identified subset within the online social community platform.

19. The one or more processor-readable storage media of claim 16, wherein the content moderation action includes removing an instance of one or more content items of the identified subset from accessible online space of at least one of the users of the online social community platform.

20. The one or more processor-readable storage media of claim 16, wherein the content moderation action includes an action directed toward a user responsible for uploading an instance of one or more content items of the identified subset to the online social community platform.
